(19) United States
(12) Patent Application Publication
(10) Pub. No.: US 2024/0422855 A1
(43) Pub. Date: Dec. 19, 2024

(54) WIRELESS PROTOCOL STACK FRAMEWORK AND COMMUNICATION METHOD BASED ON WIRELESS PROTOCOL FRAMEWORK

(71) Applicant: Beijing University of Posts and Telecommunications, Beijing (CN)

(72) Inventors: Qimei Cui, Beijing (CN); Xiyu Zhao, Beijing (CN); Yingze Wang, Beijing (CN); Xiong Li, Beijing (CN); Yanzhao Hou, Beijing (CN); Xiaofeng Tao, Beijing (CN); Ping Zhang, Beijing (CN)

(21) Appl. No.: 18/232,396

(22) Filed: Aug. 10, 2023

(30) Foreign Application Priority Data
Jun. 15, 2023 (CN) 202310716535.8

(51) Int. Cl. H04W 76/25; H04L 5/00

(52) U.S. Cl. CPC H04W 76/25; H04L 5/0007; H04W 72/54; H04W 72/56

(57) ABSTRACT

Provided are a wireless protocol stack framework and a communication method based on a wireless protocol framework. The wireless protocol stack framework includes a sending end and a receiving end. The sending end includes a first channel maintenance module and a first data processing module. The receiving end includes a second data processing module and a second channel maintenance module.

### CROSS-REFERENCE TO RELATED APPLICATIONS

This application claims the priority of Chinese patent application No. 202310716535.8, filed on Jun. 15, 2023, the entirety of which is incorporated herein by reference.

### TECHNOLOGY FIELD

The present disclosure relates to the field of communications, and in particular, to a wireless protocol stack framework and a communication method based on a wireless protocol framework.

### BACKGROUND

With the emergence of advanced and new applications in scenes, such as industrial automation, Internet of Vehicles, smart power grid, and the like, devices using the network have increasingly rigorous demands for the ultra-low latency property of the wireless network. Wireless system latency is constrained mainly by two aspects, i.e., the one refers to repetitive interactions and confirmations of control information between a sending party and a receiving party, and the other one refers to multi-layered protocol stack processing on data packets when the data packets are received and restored at the sending party and the receiving party.

### SUMMARY

The present disclosure provides a wireless protocol stack framework and a communication method based on a wireless protocol framework.

According to an aspect of the present disclosure, a wireless protocol stack framework is provided. The wireless protocol stack framework includes a sending end and a receiving end. The sending end includes a first channel maintenance module and a first data processing module. The first channel maintenance module is configured to: acquire N^{th}-run first transmission information, (N−1)^{th}-run first resource recommendation information, and (N−1)^{th}-run second resource recommendation information, N being an integer greater than or equal to 2; and predict virtual channel information based on the N^{th}-run first transmission information and the (N−1)^{th}-run first resource recommendation information, and generate N^{th}-run first resource recommendation information based on the N^{th}-run first transmission information and the (N−1)^{th}-run second resource recommendation information; and the first data processing module is in parallel with the first channel maintenance module, and is configured to: acquire first data information, process the N^{th}-run first resource recommendation information and the first data information based on the virtual channel information, and generate a target signal. The receiving end includes a second channel maintenance module and a second data processing module. The second data processing module is configured to: receive and process the target signal, so as to acquire the N^{th}-run first resource recommendation information and the first data information; and the second channel maintenance module is configured to: acquire the N^{th}-run first resource recommendation information and the N^{th}-run second transmission information, store the Nth-run first resource recommendation information, and generate the N^{th}-run second resource recommendation information based on the N^{th}-run second transmission information.

A second aspect of the present disclosure provides a communication method for a wireless protocol stack framework. The method includes: acquiring, by a first channel maintenance module, N^{th}-run first transmission information, (N−1)^{th}-run first resource recommendation information, and (N−1)^{th}-run second resource recommendation information, N being an integer greater than or equal to 2; predicting, by a first channel maintenance module, virtual channel information based on the N^{th}-run first transmission information and the (N−1)^{th}-run first resource recommendation information, and generating N^{th}-run first resource recommendation information based on the N^{th}-run first transmission information and the (N−1)^{th}-run second resource recommendation information; acquiring, by a first data processing module, first data information, processing the N^{th}-run first resource recommendation information and the first data information based on the virtual channel information, and generating a target signal; receiving, by a second data processing module, the target signal and processing the target signal, so as to acquire the N^{th}-run first resource recommendation information and the first data information; and acquiring, by a second channel maintenance module, the N^{th}-run first resource recommendation information and the N^{th}-run second transmission information, storing the N^{th}-run first resource recommendation information, and generating the N^{th}-run second resource recommendation information based on the N^{th}-run second transmission information.

In some embodiments of the present disclosure, predicting, by the first channel maintenance module, the virtual channel information based on the N^{th}-run first transmission information and the (N−1)^{th}-run first resource recommendation information includes: acquiring a prediction model. and predicting user equipment movement information and service flow information based on the prediction model and the N^{th}-run first transmission information; determining a target virtual cell based on the user equipment movement information; and generating the virtual channel information based on the target virtual cell, the service flow information, the N^{th}-run first transmission information, and the (N−1)^{th}-run first resource recommendation information, the virtual channel information including a modulation and mapping scheme and a resource block scheduling scheme.

In some embodiments of the present disclosure, determining the target virtual cell based on the user equipment movement information includes: building a corresponding first virtual cell and a corresponding second virtual cell for each user equipment based on the user equipment movement information; and determining the target virtual cell by comparing the second virtual cell with the first virtual cell, taking the second virtual cell as the target virtual cell in a case that the second virtual cell has a composition different from the first virtual cell or the second virtual cell has a newly added access point, and taking the first virtual cell as the target virtual cell in a case that the second virtual cell has the same composition as the first virtual cell.

In some embodiments of the present disclosure, generating the virtual channel information based on the target virtual cell, the service flow information, the N^{th}-run first transmission information, and the (N−1)^{th}-run first resource recommendation information includes: generating the modulation and mapping scheme based on N^{th}-run first transmission information; and generating the resource block scheduling scheme based on the modulation and mapping scheme, the target virtual cell, the service flow information, and the (N−1)^{th}-run first resource recommendation information.

In some embodiments of the present disclosure, acquiring, by the first data processing module, the first data information, processing the N^{th}-run first resource recommendation information and the first data information based on the virtual channel information, and generating the target signal include: detecting whether the first data information exists and the quantity of the first data information; setting a priority for each of pieced of first data information in a case that multiple pieces of first data information are detected; processing the first data information based on the virtual channel information and the priority, so as to generate at least one data transmission block; and processing the data transmission block based on the virtual channel information, so as to generate the target signal.

In some embodiments of the present disclosure, receiving, by the second data processing module, the target signal and processing the target signal, so as to acquire the N^{th}-run first resource recommendation information and the first data information include: processing the target signal, so as to acquire the corresponding data transmission block; and performing restoration, sorting, and recombination on data in multiple data transmission blocks, so as to acquire the first data information and the N^{th}-run first resource recommendation information.

### BRIEF DESCRIPTION OF THE DRAWINGS

Other features, objectives, and advantages of the present disclosure will become more apparent by the detailed description of non-limiting embodiments with reference to the following accompanying drawings. In the drawings:

FIG. 1A is a schematic diagram of a 5G NR user plane wireless protocol stack framework;

FIG. 1B is a schematic diagram of a 5G NR control plane wireless protocol stack framework;

FIG. 2A is a schematic diagram of a data transmission flow of a 5G NR based wireless protocol stack;

FIG. 2B is a schematic diagram of a data transmission process of a 5G NR based wireless protocol stack;

FIG. 3 is a schematic diagram of a wireless protocol stack framework according to an exemplary embodiment of the present disclosure;

FIG. 4 is a flowchart of a communication method for a wireless protocol stack framework according to an exemplary embodiment of the present disclosure;

FIG. 5 is a flowchart for generating virtual channel information according to an exemplary embodiment of the present disclosure;

FIG. 6 is a flowchart for determining a target virtual cell based on user equipment movement information and service flow information according to an exemplary embodiment of the present disclosure;

FIG. 7 is a flowchart for formulating a modulation and mapping scheme and a resource block scheduling scheme according to an exemplary embodiment of the present disclosure;

FIG. 8 is a flowchart for generating a target signal according to an exemplary embodiment of the present disclosure; and

FIG. 9 is a flowchart for processing a target signal by a receiving end according to an exemplary embodiment of the present disclosure.

### DETAILED DESCRIPTION OF THE EMBODIMENTS

For better understanding the present disclosure, various aspects of the present disclosure will be described in more detail with reference to the accompanying drawings. It should be understood that, the detailed description is only for describing exemplary embodiments of the present disclosure, rather than for limiting the scope of the present disclosure in any manner. The same reference numerals indicate the same elements throughout the description. The wording “and/or” indicates the inclusion of one of associated listed items and any or all combinations of multiple of the associated listed items.

In the drawings, for better illustration, a size, a dimension, and a shape of an element have been slightly adjusted. The drawings are illustrative only and are not drawn strictly according to the scale. As used herein, wordings such as “approximately”, “about”, and the like, are wordings for indicating approximation rather than indicating a degree, and are intended to explain an inherent deviation in a measurement value or a calculation value as recognized by a person of ordinary skills in the art. In addition, in the present disclosure, an order of respective processing steps described does not necessarily indicate an order of the processing steps in actual operations, unless the order is otherwise defined clearly or can be derived from the context.

It should further be understood that, wordings such as “comprise”, “comprised”, “have”, “include”, and/or “included” are open-ended wordings rather than closed-ended wordings in the description, indicate the existence of the mentioned features, elements, and/or components, but do not exclude the existence of one or more other features, elements, components, and/or combinations thereof. Moreover, when a wording such as “at least one of . . . ” is used before a list of stated features, the wording is used to define the entire list of features rather than an individual element in the list. Furthermore, when an embodiment of the present disclosure is described, the wording “may” is used for describing “one or more embodiments of the present disclosure”. In addition, the wording “exemplary” is intended to indicate an example or make explanations by an example.

Unless otherwise defined, all wordings used herein (including engineering terms and technical terms) have the same meanings generally understood by a person of ordinary skills in the art to which the present disclosure belongs. It should further be understood that, unless indicated clearly in the present disclosure, words defined in a commonly used dictionary shall be explained as having meanings consistent with their meanings in the art, and shall not be explained as having idealized or excessively formalized meanings.

It should be understood that, without any conflict, embodiments in the present disclosure and features in the embodiments may be combined with each other. The present disclosure is described in detail with reference to the drawings in conjunction with embodiments.

At present, in order to reduce latency of a wireless network, the following three ways are mainly adopted, including: (1) optimizing a process for data transmission, for example, by shortening a time interval of the data transmission, and optimizing a process for a hybrid automatic repeat request, so as to shorten an excessive latency caused by retransmission; (2) introducing fog computing and distributed network technology to perform data processing and computation at an edge network for reducing interaction latency with a core network; and (3) energizing an ultra-low latency network by machine learning and artificial intelligence technology, so as to effectively solve the complicated optimization problem of a lack in complete network information due to a dynamic environment and limitations of low latency. However, each of the above data communications is closed-loop communication based on the 3rd Generation Partnership Project (3GPP for short), and most of the transmission latency caused by a control signaling, such as an authorization signaling, or a pilot signaling, as well as service data processing and transmission latency within layers cannot be inhibited effectively.

Therefore, how to effectively reduce the latency of the wireless network so as to enable the wireless network to meet the requirement of ultra-low latency is an urgent problem to be solved.

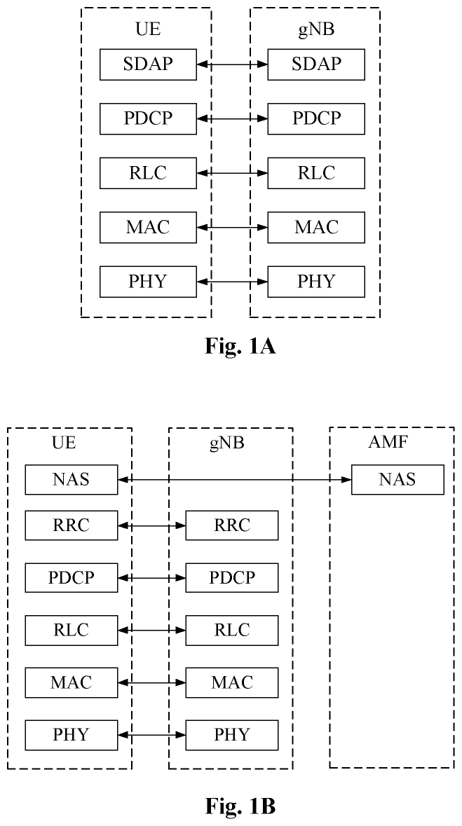

FIG. 1A is a schematic diagram of a 5G NR (5G New Radio) user plane wireless protocol stack framework. FIG. 1B is a schematic diagram of a 5G NR control plane wireless protocol stack framework. As shown in FIG. 1A and FIG. 1B, a 5G NR wireless network may include two different protocol stacks for processing different types of data between a user equipment (UE for short) and a base station (gNB), respectively. Control signaling data may be processed by a control plane wireless protocol stack, and service data may be processed by a user plane wireless protocol stack. In a wireless protocol stack framework for service data transmission and signaling data transmission, different layers perform a series of processing on data independently and sequentially so as to complete assignments of respective layers.

The user plane wireless protocol stack mainly includes a physical layer and a data link layer. The physical layer is mainly configured for information transmission on a physical channel, so as to complete processing associated with transceiving of wireless signals; and the data link layer is mainly configured for delivering user data. The physical layer (layer L1) may include a port physical layer (PHY for short); and the data link layer (layer L2) may include a media access control (MAC for short) sub-layer, a radio link control (RLC for short) sub-layer, a packet data convergence protocol (PDCP for short) sub-layer, and a service data adaptation protocol (SDAP for short) sub-layer.

The control plane wireless protocol stack mainly include a physical layer (layer L1), a data link layer (layer L2), and a network layer (layer L3). The network layer is mainly configured for connection establishment, mobility management, and security function management. The physical layer may include a PHY layer; the data link layer may include a MAC layer, an RLC layer, and a PDCP layer; and the network layer may include a radio resource control (RRC for short) protocol layer and a non-access stratum (NAS for short) layer.

In a 5G NR wireless protocol stack framework, connection for data transmission among the UE, the gNB, and the core network is necessary to be established by an RRC signaling interaction. One UE supports establishing a plurality of protocol data unit (PDU for short) sessions, and each of the PDU sessions may include multiple flows of quality of service (QOS for short). A QoS flow is the finest QoS differentiation granularity, and each of the QoS flows includes detailed information, such as a 5G QoS identifier (5GI for short), uplink and downlink maximum packet loss probabilities, and a maximum flow bitrate. At a sending end, after an upper-layer internet protocol (IP for short) flow is mapped into a QoS flow according to a certain QoS rule and is transmitted to the SDAP sub-layer, the SDAP sub-layer maps respective QoS flows onto a data radio bearer (DRB). The DRB is a channel for actual transmission of user data. A data packet is stamped with a QoS flow identifier (QFI) for classification and marking. Then, the data is processed, packaged and transmitted to a lower layer layer by layer, to complete functions of different sub-layers, and is finally transmitted in a form of radio waves. Similarly, at a receiving end, an inverse process is performed on received signals, and then the signals are transmitted to an upper layer. In this process, user plane data transmission is dependent on control signaling interactions and a closed-loop feedback mechanism. For example, in a downlink transmission, a MAC layer scheduler at a base station side performs wireless resource scheduling based on channel state information (CSI for short) and feedback information, and sends a downlink control information indicator (DCI for short) to the UE. The feedback information may include positive feedback (acknowledgement, ACK for short) information and negative feedback (negative acknowledgement, NACK for short) information.

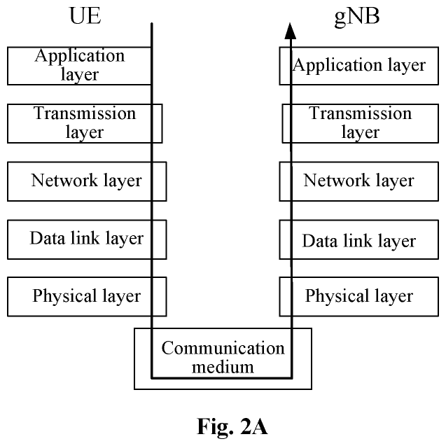

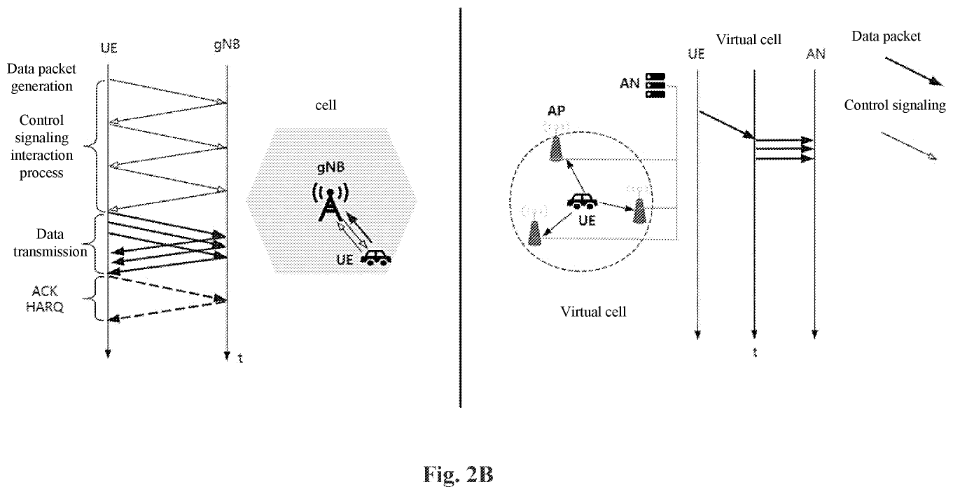

FIG. 2A is a schematic diagram of a data transmission flow of a 5G NR based wireless protocol stack. FIG. 2B is a schematic diagram of a data transmission process of the 5G NR based wireless protocol stack. As shown in FIG. 2A, a service data flow (SDF for short) is processed by an application layer and a transmission layer, and is mapped into a data flow carrying QoS requirement information, to transmit to the network layer, the data link layer, and the physical layer. Then, the service data flow is transmitted via a communication medium and arrives at the base station side, and then is transmitted through the physical layer, the data link layer, the network layer, the transmission layer and the application layer at the base station side, to complete a data transmission process. As shown in FIG. 2B, in a conventional data transmission process, when the UE needs to send data to a network side, under the premise that the UE has completed cell searching and synchronization, a random access process is necessary to further be performed to realize uplink synchronization with the gNB. The random access process includes: performing, by the UE, multiple control signaling interactions with the base station after data packets are generated at a UE side; performing data transmission according to layers based on the wireless protocol stack in FIG. 2A after the multiple control signaling interactions are completed; and acquiring feedback data (ACK/HARQ) after the data transmission is completed. Layered functions and a sequentially executed data transmission process under the 5G NR wireless protocol stack results in not inhibit effectively the latency of the process of the user data layer by layer and the latency of transmitting of control signaling feedback.

FIG. 3 is a schematic diagram of a wireless protocol stack framework 1000 according to an exemplary embodiment of the present disclosure. As shown in FIG. 3, the wireless protocol stack framework 1000 may include a sending end 1100 and a receiving end 1200. The sending end 1100 may include a first channel maintenance module 1110 and a first data processing module 1120, and the receiving end 1200 may include a second channel maintenance module 1210 and a second data processing module 1220.

In an exemplary embodiment of the present disclosure, the first channel maintenance module 1110 of the sending end 1100 is configured to: acquire N^{th}-run first transmission information, (N−1)^{th}-run first resource recommendation information, and (N−1)^{th}-run second resource recommendation information, N being an integer greater than or equal to 2; and predict virtual channel information based on the N^{th}-run first transmission information and the (N−1)^{th}-run first resource recommendation information, and generate N^{th}-run first resource recommendation information based on the N^{th}-run first transmission information and the (N−1)^{th}-run second resource recommendation information. The first data processing module 1120 is in parallel with the first channel maintenance module 1110, and is configured to: acquire first data information, process the N^{th}-run first resource recommendation information and the first data information based on the virtual channel information, and generate a target signal. The sending end 1100 may further include an application layer 1130 and a transmission layer 1140. The application layer 1130 may provide a service for an application, i.e., implementing a specific network application by interactions between application processes; and the transmission layer 1140 may establish port-to-port communications. The N^{th}-run first transmission information may include channel state information, service prediction information, user equipment position prediction information, and real-time environment information. The (N−1)^{th}-run first resource recommendation information is the first resource recommendation information generated by the first channel maintenance module in a previous transmission run. The (N−1)^{th}-run second resource recommendation information is the second resource recommendation information generated by the second channel maintenance module in the previous transmission run.

In an exemplary embodiment of the present disclosure, the first channel maintenance module may further be configured to predict the virtual channel information based on the N^{th}-run first transmission information and the (N−1)^{th}-run first resource recommendation information, and the virtual channel information may include a resource block scheduling scheme and a modulation and mapping scheme. Generating the virtual channel information may include: acquiring a prediction model, and predicting user equipment movement information and service flow information based on the prediction model and the N^{th}-run first transmission information; determining a target virtual cell based on the user equipment movement information; and generating the virtual channel information based on the target virtual cell, the service flow information, the N^{th}-run first transmission information, and the (N−1)^{th}-run first resource recommendation information. The virtual channel information includes the modulation and mapping scheme and the resource block scheduling scheme.

In an exemplary embodiment of the present disclosure, in order that the first data processing module may process data in time when the data arrives at the first data processing module, the first channel maintenance module may predict the virtual channel information in advance. Exemplarily, the first channel maintenance module may predict the user equipment movement information and the service flow information based on the prediction model and the N^{th}-run first transmission information. The user equipment movement information may include a user equipment trajectory, and the service flow information may include a size of an uplink service flow and a size of a downlink service flow.

In an exemplary embodiment of the present disclosure, a mobile equipment UE may be actively connected to multiple access points (APs for short) to form a virtual cell with the mobile equipment UE as the center, so as to provide communication reliability by spatial multiplexing and performing a coordinated multiple point (COMP for short) collaboration transmission technology with the multiple APs connected with the mobile equipment UE. All APs in the virtual cell are managed by an anchor node (AN). In an uplink, each mobile equipment UE performs unauthorized transmission by an active association technology, and the mobile equipment UE may independently and actively select the network and wireless resources, so that the mobile equipment UE is no longer necessary to perform signaling interactions with the AN so as to acquire resource allocation and access control information. In a downlink, the AN performs centralized management on the APs and the wireless resources by fog computing or edge computing and an anticipated mobility management technology, so as to provide a service for a large number of users within its coverage area.

In an exemplary embodiment of the present disclosure, determining the target virtual cell based on the user equipment movement information may include: building a corresponding first virtual cell and a corresponding second virtual cell for each user equipment based on the user equipment movement information; and determining the target virtual cell by comparing the second virtual cell with the first virtual cell. If the second virtual cell has a composition different from that of the first virtual cell or the second virtual cell has a newly added access point, the second virtual cell is used as the target virtual cell, otherwise the first virtual cell is used as the target virtual cell.

Exemplarily, a current transmission time is a time t. At a time t−1, the first channel maintenance module may allocate a proper access point for each user equipment based on the user equipment movement information at the time t, so as to build a first virtual cell, with each user equipment as the center, corresponding to the time t for each user equipment. Then, a proper access point is allocated for each user equipment again based on the user equipment movement information at the time t+1, so as to build a second virtual cell at the time t+1. The second virtual cell is compared with the first virtual cell. If the second virtual cell has the same composition as the first virtual cell, the first virtual cell is used as the target virtual cell; and if the second virtual cell has a composition different from the first virtual cell or the second virtual cell is detected to have a newly added access point, the first channel maintenance module performs a switching of the virtual cell from the first virtual cell to the second virtual cell, i.e., taking the second virtual cell as the target virtual cell.

In an exemplary embodiment of the present disclosure, after the target virtual cell is determined, the first channel maintenance module 1110 may further generate the modulation and mapping scheme and the resource block scheduling scheme. Generating the modulation and mapping scheme and the resource block scheduling scheme may include: generating the modulation and mapping scheme based on the N^{th}-run first transmission information; and generating the resource block scheduling scheme based on the modulation and mapping scheme, the target virtual cell, the service flow information, and the (N−1)^{th}-run first resource recommendation information.

Exemplarily, the first channel maintenance module may generate the modulation and mapping scheme according to the N^{th}-run first transmission information. The modulation and mapping scheme may include a modulation manner, the quantity of layers, and a transmission power. Then, the resource block scheduling scheme is generated based on the modulation and mapping scheme, the target virtual cell, the service flow information, and the (N−1)^{th}-run first resource recommendation information. The resource block scheduling scheme may include dynamically and randomly selecting the positions and the quantity of occupied resource blocks when the user equipment performs transmission at each access point in the corresponding target virtual cell.

In an exemplary embodiment of the present disclosure, the first channel maintenance module 1110 may further configured to generate the N^{th}-run first resource recommendation information based on the N^{th}-run first transmission information and the (N−1)^{th}-run second resource recommendation information. In some embodiments, the first channel maintenance module 1110 sends the virtual channel information and the N^{th}-run first resource recommendation information to the first data processing module 1120.

According to exemplary embodiments of the present disclosure, the first channel maintenance module generates the virtual channel information and the N^{th}-run first resource recommendation information, and sends data based on the virtual channel information in a subsequent process, which saves a process of signaling interactions between the sending end and the output end and reduces the latency of a communication process. In addition, by randomly selecting the positions and the quantity of occupied different resource blocks, encryption of a data flow can be realized to a degree, so as to ensure that the data cannot be intercepted completely, thereby improving the security of data transmission.

In an exemplary embodiment of the present disclosure, the first data processing module 1120 is in parallel with the first channel maintenance module 1110, and the first data processing module 1120 is configured to: acquire the first data information, process the N^{th}-run first resource recommendation information and the first data information based on the virtual channel information, and generate the target signal. Generating the target signal may include: detecting whether the first data information exists and the quantity of the first data information; if multiple pieces of first data information are detected, setting a priority for the pieces of first data information; processing the first data information based on the virtual channel information and the priority, so as to generate at least one data transmission block; and processing the data transmission block based on the virtual channel information, so as to generate a target signal.

Exemplarily, first, whether the first data information exists in the first data processing module 1120 is detected, and the quantity of the first data information is detected if the first data information exists. The first data information includes data flow information and requirement information for a service quality flow, or the first data information includes the data flow information, the requirement information for the service quality flow and the priority information of the user equipment. If multiple pieces of first data information are detected, a priority is set for each of the pieces of first data information. For example, a higher priority is set for the first data information having a higher latency requirement, and a lower priority is set for the first data information having a lower latency requirement. Then, the first data information is processed based on the virtual channel information and the priority, so as to generate at least one data transmission block. For example, when there are multiple access points APs in the virtual cell of the user equipment, the first data information may be sent by a portion of or all of the access points APs selected from the multiple access points APs, and segmentation processing or multiplexing processing are performed on the first data information based on the priority and the virtual channel information, so as to generate the corresponding data transmission block. Optionally, the first data processing module 1120 may further be configured to duplicate the first data information based on virtual cell information of the user equipment, so as to generate multiple pieces of first data information. In some embodiments, the data transmission block is processed based on the virtual channel information, so as to generate the target signal. For example, cyclic redundancy check (CRC for short) attachment, rate matching, modulation, layer mapping, multiple-input multiple-output (MIMO for short) pre-coding, antenna port mapping, and wireless resource mapping may be performed on the received data transmission block, so as to generate the target signal.

In an exemplary embodiment of the present disclosure, the second data processing module 1220 is configured to: receive the target signal and process the target signal, so as to acquire the N^{th}-run first resource recommendation information and the first data information. The second channel maintenance module 1210 is configured to: acquire the N^{th}-run first resource recommendation information and the N^{th}-run second transmission information, store the Nth-run first resource recommendation information, and generate the N^{th}-run second resource recommendation information based on the N^{th}-run second transmission information. The receiving end 1200 may further include an application layer 1130 and a transmission layer 1140. The application layer 1130 may provide a service for an application, i.e., implementing a specific network application by interactions between application processes; and the transmission layer 1140 may establish port-to-port communication.

In an exemplary embodiment of the present disclosure, processing the target signal by the second data processing module 1220 may include: processing the target signal, so as to acquire a corresponding data transmission block; performing restoration, sorting, and recombination on data in multiple data transmission blocks, so as to acquire the first data information and the N^{th}-run first resource recommendation information.

Exemplarily, since the user equipment may receive the same data flow sent by multiple access points APs, there may be a circumstance that segmented data flows are repetitive. Therefore, the second data processing module 1220 needs to perform repeatability check on the data transmission blocks to remove the same data transmission block. Then, the second data processing module 1220 may perform detection and restoration processing on the received data transmission blocks, and a process of data processing may be an inverse process of processing the data by the sending end. For example, the second data processing module 1220 may perform data processing such as wireless resource de-mapping, channel estimation and equalization, layer de-mapping, demodulation, de-rate matching, and the CRC check, and perform sorting and recombination on the data in the multiple data transmission blocks, so as to restore the first data information and the N^{th}-run first resource recommendation information.

In an exemplary embodiment of the present disclosure, the second channel maintenance module 1210 may acquire the N^{th}-run first resource recommendation information and the N^{th}-run second transmission information, store the N^{th}-run first resource recommendation information, and generate the N^{th}-run second resource recommendation information based on the N^{th}-run second transmission information. Exemplarily, the N^{th}-run second transmission information may include receiving signal information, channel state information, local state information, and arrival angle information. The second channel maintenance module stores the N^{th}-run first resource recommendation information, so as to guide to generate the virtual channel information at the (N+1)^{th}-run; and the second channel maintenance module 1210 may further update the (N−1)^{th}-run second resource recommendation information based on the N^{th}-run second transmission information, so as to generate the N^{th}-run second resource recommendation information.

According to embodiments of the present disclosure, the first channel maintenance module and the first data processing module are provided at the sending end, and the second channel maintenance module and the second data processing module are provided at the receiving end, which reduces the latency and overhead of vertical layer-by-layer processing and reduce the latency of layer-by-layer transmission of data. In addition, a control signaling interaction process between a user side and a network side for a single data transmission is saved, thereby further reducing the communication latency.

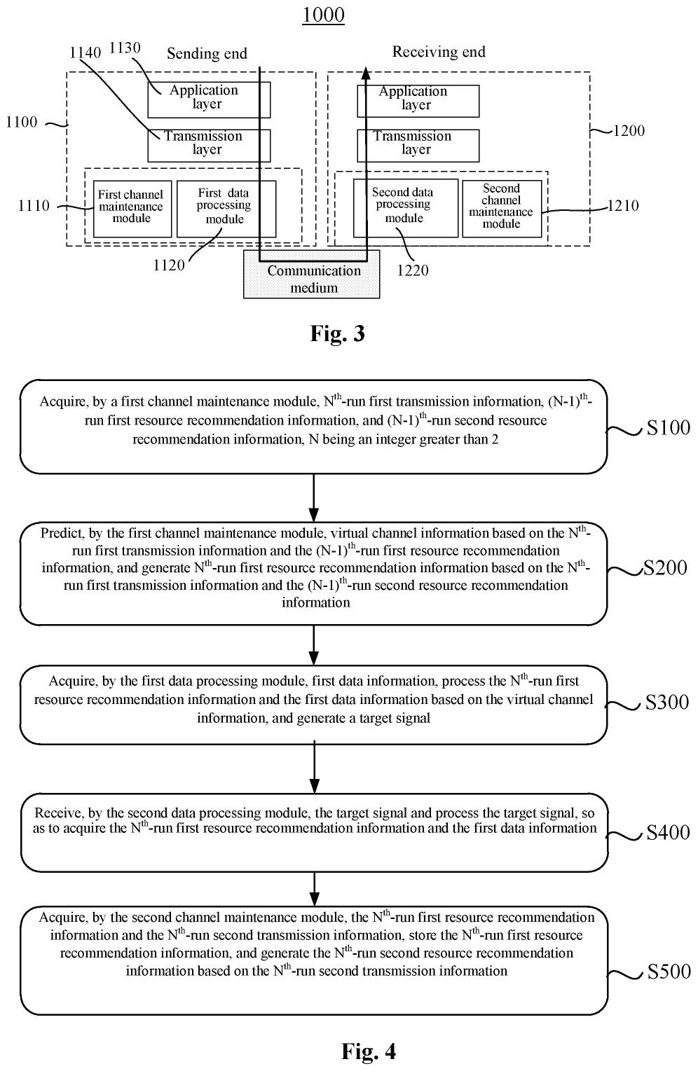

FIG. 4 is a flowchart of a communication method for a wireless protocol stack framework according to an exemplary embodiment of the present disclosure. As shown in FIG. 4, the communication method for the wireless protocol stack framework may include steps S100 to S500.

At step S100, a first channel maintenance module acquires N^{th}-run first transmission information, (N−1)^{th}-run first resource recommendation information and (N−1)^{th}-run second resource recommendation information, N being an integer greater than or equal to 2.

At step S200, the first channel maintenance module predicts virtual channel information based on the N^{th}-run first transmission information and the (N−1)^{th}-run first resource recommendation information, and generates N^{th}-run first resource recommendation information based on the N^{th}-run first transmission information and the (N−1)^{th}-run second resource recommendation information.

At step S300, a first data processing module acquires first data information, processes the N^{th}-run first resource recommendation information and the first data information based on the virtual channel information, and generates a target signal.

At step S400, a second data processing module receives the target signal and processes the target signal, so as to acquire the N^{th}-run first resource recommendation information and the first data information.

At step S500, a second channel maintenance module acquires the N^{th}-run first resource recommendation information and N^{th}-run second transmission information, stores the N^{th}-run first resource recommendation information, and generates N^{th}-run second resource recommendation information based on the N^{th}-run second transmission information.

The respective steps of a switching method for a wireless local area network will be described in detail below.

### Step S100 and step S200

In an exemplary embodiment of the present disclosure, when the receiving end completes one data reception, one run is counted. An example is given by taking a current data transmission as an N^{th}-run data transmission. The first channel maintenance module acquires the N^{th}-run first transmission information, the (N−1)^{th}-run first resource recommendation information, and the (N−1)^{th}-run second resource recommendation information, N being an integer greater than or equal to 2. The N^{th}-run first transmission information may include channel state information, service prediction information, user equipment position prediction information, and real-time environment information. The (N−1)^{th}-run first resource recommendation information is the first resource recommendation information generated by the first channel maintenance module in a previous transmission run. The (N−1)^{th}-run second resource recommendation information is the second resource recommendation information generated by the second channel maintenance module in a previous transmission run.

In an exemplary embodiment of the present disclosure, the first channel maintenance module may further predict virtual channel information based on the N^{th}-run first transmission information and the (N−1)^{th}-run first resource recommendation information. The virtual channel information may include a resource block scheduling scheme and a modulation and mapping scheme.

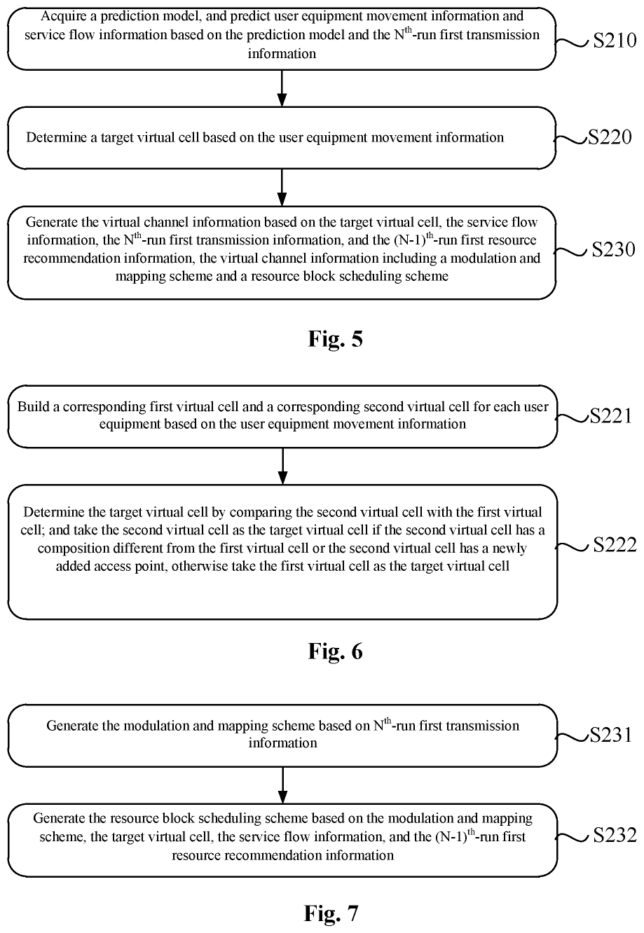

FIG. 5 is a flowchart for generating the virtual channel information according to an exemplary embodiment of the present disclosure. As shown in FIG. 5, generating the virtual channel information may include steps S210 to S230.

At step S210, a prediction model is acquired, and the user equipment movement information and the service flow information are predicted based on the prediction model and the N^{th}-run first transmission information.

At step S220, a target virtual cell is determined based on the user equipment movement information.

At step S230, the virtual channel information is generated based on the target virtual cell, the service flow information, the N^{th}-run first transmission information, and the (N−1)^{th}-run first resource recommendation information. The virtual channel information includes a modulation and mapping scheme and a resource block scheduling scheme.

In an exemplary embodiment of the present disclosure, in order that the first data processing module may process data in time when the data arrives at the first data processing module, the first channel maintenance module may predict the virtual channel information in advance. Exemplarily, the first channel maintenance module may predict the user equipment movement information and the service flow information based on the prediction model and the N^{th}-run first transmission information. The user equipment movement information may include a user equipment trajectory, and the service flow information may include a size of an uplink service flow and a size of a downlink service flow.

In an exemplary embodiment of the present disclosure, a mobile equipment UE may be actively connected to multiple access points (APs for short) to form a virtual cell with the mobile equipment UE as the center, so as to provide communication reliability by spatial multiplexing and performing a coordinated multiple point (COMP for short) collaboration transmission technology with multiple APs connected with the mobile equipment UE. All APs in the virtual cell are managed by an anchor node (AN). In an uplink, each mobile equipment UE performs unauthorized transmission by an active association technology, and the mobile equipment UE may independently and actively select the network and wireless resources, so that the mobile equipment UE is no longer necessary to perform signaling interactions with the AN so as to acquire resource allocation and access control information. In a downlink, the AN performs centralized management on the APs and the wireless resources by fog computing or edge computing and an anticipated mobility management technology, so as to provide a service for a large number of users within its coverage area.

FIG. 6 is a flowchart for determining the target virtual cell based on the user equipment movement information and the service flow information according to an exemplary embodiment of the present disclosure. As shown in FIG. 6, determining the target virtual cell based on the user equipment movement information may include steps S221 to S222.

At step S221, a corresponding first virtual cell and a corresponding second virtual cell is built for each user equipment based on the user equipment movement information.

At step S222, the target virtual cell is determined by comparing the second virtual cell with the first virtual cell. If the second virtual cell has a composition different from that of the first virtual cell or the second virtual cell has a newly added access point, the second virtual cell is used as the target virtual cell, otherwise the first virtual cell is used as the target virtual cell.

Exemplarily, a current transmission time is a time t. At a time t−1, the first channel maintenance module may allocate a proper access point for each user equipment based on the user equipment movement information corresponding at the time t, so as to build a first virtual cell, with the each user equipment as the center, corresponding to the time t for each user equipment. Then, a proper access point is allocated for each user equipment again based on user equipment movement information at the time t+1, so as to build a second virtual cell corresponding to the time t+1. The second virtual cell is compared with the first virtual cell. If the second virtual cell has the same composition as the first virtual cell, the first virtual cell is used as the target virtual cell; and if the second virtual cell has a composition different from the first virtual cell or the second virtual cell is detected to have a newly added access point, the first channel maintenance module performs a switching of the virtual cell from the first virtual cell to the second virtual cell, i.e., taking the second virtual cell as the target virtual cell.

In an exemplary embodiment of the present disclosure, after the target virtual cell is determined, the modulation and mapping scheme and the resource block scheduling scheme may further be generated based on the target virtual cell, the service flow information, the N^{th}-run first transmission information, and the (N−1)^{th}-run first resource recommendation information. FIG. 7 is a flowchart for formulating the modulation and mapping scheme and the resource block scheduling scheme according to an exemplary embodiment of the present disclosure. As shown in FIG. 7, formulating the modulation and mapping scheme and the resource block scheduling scheme may include steps S231 and S232.

At step S231, the modulation and mapping scheme is generated based on the N^{th}-run first transmission information.

At step S232, the resource block scheduling scheme is generated based on the modulation and mapping scheme, the target virtual cell, the service flow information, and the (N−1)^{th}-run first resource recommendation information.

Exemplarily, the first channel maintenance module may generate the modulation and mapping scheme according to the N^{th}-run first transmission information. The modulation and mapping scheme may include a modulation manner, the quantity of layers, and a transmission power. Then, the resource block scheduling scheme is generated based on the modulation and mapping scheme, the target virtual cell, the service flow information, and the (N−1)^{th}-run first resource recommendation information. The resource block scheduling scheme may include dynamically and randomly selecting the positions and the quantity of occupied resource blocks when the user equipment performs transmission at each access point in the corresponding target virtual cell.

In an exemplary embodiment of the present disclosure, the first channel maintenance module may further generate the N^{th}-run first resource recommendation information based on the N^{th}-run first transmission information and the (N−1)^{th}-run second resource recommendation information. In some embodiments, the first channel maintenance module sends the virtual channel information and the N^{th}-run first resource recommendation information to the first data processing module.

According to exemplary embodiments of the present disclosure, the first channel maintenance module generates the virtual channel information and the N^{th}-run first resource recommendation information, and sends data based on the virtual channel information in a subsequent process, which saves a process of signaling interactions between the sending end and the output end and reduces the latency of a communication process. In addition, by randomly selecting the positions and the quantity of occupied different resource blocks, encryption of a data flow can be realized to a degree, so as to ensure that the data cannot be intercepted completely, thereby improving the security of data transmission.

### Step S300

In an exemplary embodiment of the present disclosure, after the first channel maintenance module generates the virtual channel information and the N^{th}-run first resource recommendation information, the first data processing module may acquire first data information, process the N^{th}-run first resource recommendation information and the first data information based on the virtual channel information, and generate a target signal. FIG. 8 is a flowchart for generating the target signal according to an exemplary embodiment of the present disclosure. As shown in FIG. 8, generating the target signal may include the following steps S310 to S340.

At step S310, whether the first data information exists and the quantity of the first data information are detected.

At step S320, if multiple pieces of first data information are detected, a priority is set for each of the pieces of first data information.

At step S330, the first data information is processed based on the virtual channel information and the priority, so as to generate at least one data transmission block.

At step S340, the data transmission block is processed based on the virtual channel information, so as to generate the target signal.

Exemplarily, first, whether the first data information exists in the first data processing module is detected, and the quantity of the first data information is detected if the first data information exists. The first data information includes data flow information, requirement information of a service quality flow, or the first data information includes the data flow information, the requirement information of the service quality flow and priority information of the user equipment. If multiple pieces of first data information are detected, a priority is set for each of the pieces of first data information. For example, a higher priority is set for the first data information having a higher latency requirement, and a lower priority is set for the first data information having a lower latency requirement. Then, the first data information is processed based on the virtual channel information and the priority, so as to generate at least one data transmission block. For example, when there are multiple access points APs in the virtual cell of the user equipment, the first data information may be sent to a portion of or all of the access points APs selected from the multiple access points APs, and segmentation processing or multiplexing processing are performed on the first data information based on the priority and the virtual channel information, so as to generate the corresponding data transmission block. Optionally, the first data processing module may further duplicate the first data information based on virtual cell information of the user equipment, so as to generate multiple pieces of first data information. In some embodiments, the data transmission block is processed based on the virtual channel information, so as to generate the target signal. For example, cyclic redundancy check (CRC for short) attachment, rate matching, modulation, layer mapping, multiple-input multiple-output (MIMO for short) pre-coding, antenna port mapping, and wireless resource mapping may be performed on the received data transmission block, so as to generate the target signal.

### Step S400

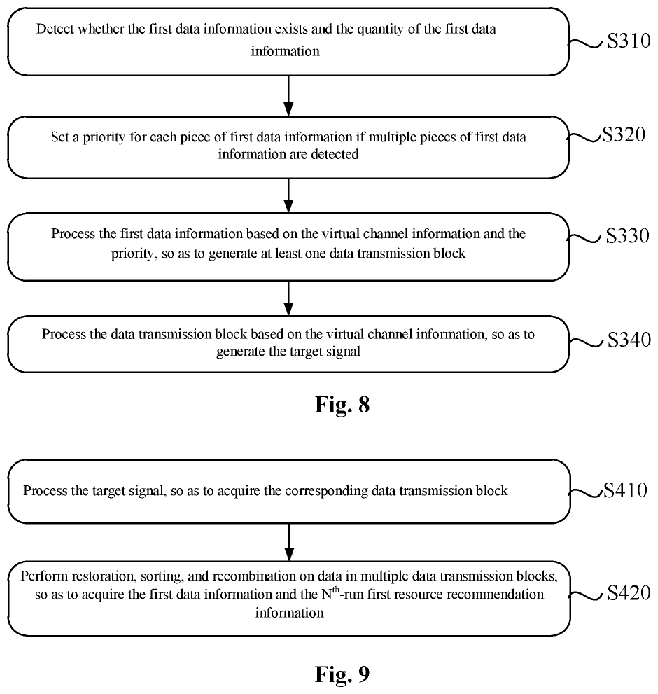

In an exemplary embodiment of the present disclosure, the first data processing module sends the target signal, and the second data processing module of the receiving end receives the target signal and processes the target signal, so as to acquire the N^{th}-run first resource recommendation information and the first data information. FIG. 9 is a flowchart for processing the target signal by the receiving end according to an exemplary embodiment of the present disclosure. As shown in FIG. 9, processing the target signal by the receiving end may include the following steps S410 and S420.

At step S410, the target signal is processed, so as to acquire the corresponding data transmission block.

At step S420, restoration, sorting, and recombination are performed on data in multiple data transmission blocks, so as to acquire the first data information and the N^{th}-run first resource recommendation information.

Exemplarily, since the user equipment may receive the same data flow sent by multiple access points APs, segmented data flows may be repetitive. Therefore, the second data processing module needs to perform a repeatability check on the data transmission blocks to remove the same data transmission block. Then, the second data processing module may perform detection and restoration processing on the received data transmission blocks, and a process of data processing may be an inverse process of processing the data by the sending end. For example, the second data processing module may perform data processing, such as wireless resource de-mapping, channel estimation and equalization, layer de-mapping, demodulation, de-rate matching, and the CRC check, and perform sorting and recombination on the data in the multiple data transmission blocks, so as to restore the first data information and the N^{th}-run first resource recommendation information.

### Step S500

In an exemplary embodiment of the present disclosure, after the first data information and the N^{th}-run first resource recommendation information are acquired the second channel maintenance module acquires the N^{th}-run first resource recommendation information and N^{th}-run second transmission information, stores the N^{th}-run first resource recommendation information, and generates N^{th}-run second resource recommendation information based on the N^{th}-run second transmission information. Exemplarily, the N^{th}-run second transmission information may include receiving signal information, channel state information, local state information, and arrival angle information. The second channel maintenance module stores the N^{th}-run first resource recommendation information, so as to guide to generate the virtual channel information at the (N+1)^{th}-run; and the second channel maintenance module may further update the (N−1)^{th}-run second resource recommendation information based on the N^{th}-run second transmission information, so as to generate the N^{th}-run second resource recommendation information.

According to embodiments of the present disclosure, the first channel maintenance module and the first data processing module are provided at the sending end, and the second channel maintenance module and the second data processing module are provided at the receiving end, so as to transmit data, which reduces the latency and overhead of vertical layer-by-layer processing and reduce the latency of layer-by-layer transmission of data. In addition, a control signaling interaction process between a user side and a network side for a single data transmission is saved, thereby further reducing the communication latency.

The above specific embodiments further describe objectives, technical solutions, and beneficial effects of the present disclosure. It should be understood that, the above description only involves the specific embodiments of the present disclosure, and is not used for limiting the present disclosure. Any amendment, equivalent replacement, and improvement made within the spirit and principle of the present disclosure shall all fall into the protection scope of the present disclosure.

1. A wireless protocol stack framework, comprising: a sending end and a receiving end, wherein
the sending end comprises a first channel maintenance module and a first data processing module; and the receiving end comprises a second channel maintenance module and a second data processing module;
the first channel maintenance module is configured to: acquire N^{th}-run first transmission information, (N−1)^{th}-run first resource recommendation information, and (N−1)^{th}-run second resource recommendation information, N being an integer greater than or equal to 2; and predict virtual channel information based on the N^{th}-run first transmission information and the (N−1)^{th}-run first resource recommendation information, and generate N^{th}-run first resource recommendation information based on the N^{th}-run first transmission information and the (N−1)^{th}-run second resource recommendation information;
the first data processing module is in parallel with the first channel maintenance module, and is configured to: acquire first data information, process the N^{th}-run first resource recommendation information and the first data information based on the virtual channel information to generate a target signal;
the second data processing module is configured to: receive and process the target signal, so as to acquire the N^{th}-run first resource recommendation information and the first data information; and
the second channel maintenance module is configured to: acquire the N^{th}-run first resource recommendation information and N^{th}-run second transmission information, store the N^{th}-run first resource recommendation information, and generate the N^{th}-run second resource recommendation information based on the N^{th}-run second transmission information.

2. A communication method for a wireless protocol stack framework, comprising:
acquiring, by a first channel maintenance module, N^{th}-run first transmission information, (N−1)^{th}-run first resource recommendation information, and (N−1)^{th}-run second resource recommendation information, N being an integer greater than or equal to 2;
predicting, by the first channel maintenance module, virtual channel information based on the N^{th}-run first transmission information and the (N−1)^{th}-run first resource recommendation information, and generating N^{th}-run first resource recommendation information based on the N^{th}-run first transmission information and the (N−1)^{th}-run second resource recommendation information;
acquiring, by a first data processing module, first data information, and processing the N^{th}-run first resource recommendation information and the first data information based on the virtual channel information to generate a target signal;
receiving, by a second data processing module, the target signal and processing the target signal, so as to acquire the N^{th}-run first resource recommendation information and the first data information; and
acquiring, by a second channel maintenance module, the N^{th}-run first resource recommendation information and N^{th}-run second transmission information, storing the Nth-run first resource recommendation information, and generating N^{th}-run second resource recommendation information based on the N^{th}-run second transmission information.

3. The communication method for the wireless protocol stack framework according to claim 2, wherein
predicting, by the first channel maintenance module, the virtual channel information based on the N^{th}-run first transmission information and the (N−1)^{th}-run first resource recommendation information comprises:
acquiring a prediction model, and predicting user equipment movement information and service flow information based on the prediction model and the N^{th}-run first transmission information;
determining a target virtual cell based on the user equipment movement information; and
generating the virtual channel information based on the target virtual cell, the service flow information, the N^{th}-run first transmission information, and the (N−1)^{th}-run first resource recommendation information, wherein the virtual channel information comprises a modulation and mapping scheme and a resource block scheduling scheme.

4. The communication method for the wireless protocol stack framework according to claim 3, wherein
determining the target virtual cell based on the user equipment movement information comprises:
building a corresponding first virtual cell and a corresponding second virtual cell for each user equipment based on the user equipment movement information; and
determining the target virtual cell by comparing the second virtual cell with the first virtual cell; wherein in a case that the second virtual cell has a composition different from the first virtual cell or the second virtual cell has a newly added access point, the second virtual cell is used as the target virtual cell, and in a case that the second virtual cell has the same composition as the first virtual cell, the first virtual cell is used as the target virtual cell.

5. The communication method for the wireless protocol stack framework according to claim 3, wherein
generating the virtual channel information based on the target virtual cell, the service flow information, the N^{th}-run first transmission information, and the (N−1)^{th}-run first resource recommendation information comprises:
generating the modulation and mapping scheme based on the N^{th}-run first transmission information; and
generating the resource block scheduling scheme based on the modulation and mapping scheme, the target virtual cell, the service flow information, and the (N−1)^{th}-run first resource recommendation information.

6. The communication method for the wireless protocol stack framework according to claim 2, wherein
acquiring, by the first data processing module, the first data information, processing the N^{th}-run first resource recommendation information and the first data information based on the virtual channel information, and generating the target signal comprise:
detecting whether the first data information exists and the quantity of the first data information;
setting a priority for each of pieces of first data information in a case where multiple pieces of first data information are detected;
processing the first data information based on the virtual channel information and the priority, so as to generate at least one data transmission block; and
processing the data transmission block based on the virtual channel information, so as to generate the target signal.

7. The communication method for the wireless protocol stack framework according to claim 6, wherein receiving, by the second data processing module, the target signal and processing the target signal, so as to acquire the N^{th}-run first resource recommendation information and the first data information comprise:
processing the target signal, so as to acquire a corresponding data transmission block; and
performing restoration, sorting, and recombination on data in multiple data transmission blocks, so as to acquire the first data information and the N^{th}-run first resource recommendation information.
